(19) United States
(12) Patent Application Publication
(10) Pub. No.: US 2009/0199334 A1
(43) Pub. Date: Aug. 13, 2009

(54) Deep skin cleaning apparatus

(76) Inventors: Leon Emmanuel Jew, Pleasanton, CA (US); Sydney Furan Huang, Pleasanton, CA (US)

Correspondence Address: LEON E. JEW, Suite 288, 5776 Stoneridge Mall Rd., Pleasanton, CA, 94588, US

(21) Appl. No.: 12/378,344

(22) Filed: Feb. 12, 2009

Related U.S. Application Data
(60) Provisional application No. 61/065,517, filed on Feb. 12, 2008.

(51) Int. Cl. A61H 33/00

(52) U.S. Cl. 4/616

(57) ABSTRACT

The invention teaches a device for deep skin cleansing. The device includes a dispenser, with one or more outlets, for dispensing a beam or beams of high-pressured water, a switch or button for controlling release of the high-pressured water beam, and a source for providing high-pressured water such as a pre-filled canister or a powered pump.

### REFERENCE TO RELATED APPLICATION

The present application claims priority to the provisional Appl. Ser. No. 61/065,517 filed on Feb. 12, 2008, the entire content of which is hereby incorporated by reference.

### FIELD OF THE INVENTION

This invention relates generally to human skin care technology. In particular, the invention relates to an apparatus for human skin deep cleansing using high-pressured water or other liquid as media.

### BACKGROUND OF THE INVENTION

Well-being, beauty and personal hygiene require regular skin cleaning. The primitive way of skin cleaning is to apply water to the skin and rub the skin with hands at the same time. However, due to the accumulation of dirt, oils, and dead skin, the primitive way is not effective in many circumstances.

Various solutions have been developed. For example, bar soap and liquid soap are commonly used to clean dirt, oils, and dead skin. Most soap contains ingredients such as ammonium laurel sulfate and sodium laurel sulfate, which are harsh and irritating to the skin.

To overcome the negative effects of soap, more sophisticated deep skin cleaning products have been developed. These products fall in three categories. The first category includes gel, cream or liquid containing various additives such as chemicals, botanicals, Vitamins, glycerin, natural oils and extracts. The thinking of the designers of this category of products is based on the assumption that the applied gel, cream or liquid would not create impurities in the sweat pores while they are acting as a cleaning agent. In fact, the additives may become pollutants if they are not used properly.

The second category includes various face scrubs or sponges. As an example, a deep face cleaning scrub, utilizing polyethylene beads enriched with certain nutritional ingredients such as Aloe Vera and vitamins, is designed to remove skin impurities and dead skin cells. The problem of this category of products is that to do deep cleaning, the user must apply some liquid or gel to the scrub or sponge first, mix a small amount of water, then with a circular motion lightly rub and scrub the skin using the loaded scrub or sponge, then rinse the skin using water, and then dry the skin using tissue or towel.

The third category includes all kind of brushes. The post popular one is an electrical powered handheld facial care system which uses sonic technology to gently exfoliate and deep clean the skin. This category of products has the same problem of the second category, except the rubbing and scrubbing motions are driven by mini-motors instead of applying rubbing and scrubbing force manually.

Dry skin, damaged or prematurely sun-aged skin need to be moisturized. Various moisture creams are designed to help reduce fine lines while hydrating, protecting, and guarding against dry and chapped skin. The problem is that the user needs to apply a small amount of cream to dampened skin and the cream itself may become impurities.

What is desired is an easy-to-use means to clean impurities from skin and at the same time hydrating the skin in a quick manner.

### SUMMARY OF THE INVENTION

The present invention teaches an apparatus for deep skin cleansing. The apparatus includes a means for dispensing a beam of high-pressured water, a means for controlling release of the water beam; and a means for providing high-pressured water. The means for dispensing includes one outlet or multiple rows of outlets. The means for providing high-pressured water can be a replaceable canister prefilled with high-pressured water or a powered pump. In another preferred embodiment, the apparatus further includes a means for sucking splashed water from surface area of the skin. The suction means includes a pipe connected to a powered pump and an inlet parallel to the outlet(s) of the dispensing means. The apparatus may further includes a means for activating the suction means such as a button which can be controlled manually. The apparatus may further include an adjustable nozzle attachment for adjusting distance from the dispensing means. The apparatus may further include a removable brush attached to the dispensing means. Finally, the apparatus may further include a cleansing pad attached to the dispensing means.

### BRIEF DESCRIPTION OF THE DRAWINGS

FIG. 1 is a schematic diagram illustrating an enlarged view of a pore of human skin;

FIG. 2 is a schematic diagram illustrating an apparatus with a single layer dispenser for deep cleaning according to one preferred embodiment of the invention;

FIG. 3 is a schematic diagram illustrating an apparatus with a multi-layer dispenser for deep cleaning according to another preferred embodiment of the invention;

FIG. 4 is a schematic diagram illustrating the body of the handheld apparatus with a button for the user to control the water pressure;

FIG. 5 is a schematic diagram illustrating the dispenser handle and the button according to the invention;

FIG. 6 is a schematic block diagram illustrating the apparatus and the supply system according to the invention;

FIG. 7 is a schematic diagram illustrating a dispenser with a suction inlet for removing waters; and

FIG. 8 is a schematic diagram illustrating the dispenser with an adjustable nozzle.

### DESCRIPTION OF THE INVENTION

Accumulation of dirt, oils, and dead skin cells causes problem skin, poor complexion, and acne. The traditional ways of deep cleansing may be either ineffective or have negative effects. The invention provides a revolutionary way to remove immunities from human skin and to hydrate the skin concurrently.

The central concept of the invention is that when the high-pressured water beam or stream hits the skin, some high-speed water molecules splash the impurities off from the skin, and some high-speed water molecules enter the first layer of the skin through the sweat pores, and some other high-speed water molecules, by millions of discrete micro-striking actions, massage the skin surface to decrease or even remove wrinkles. The size of the outlet for the beam or stream is designed at nano-level. The pressure of the beam or stream must be precisely controlled such that the pressure is high enough for splashing the immunities off but within the threshold at which the skin may probably be injured.

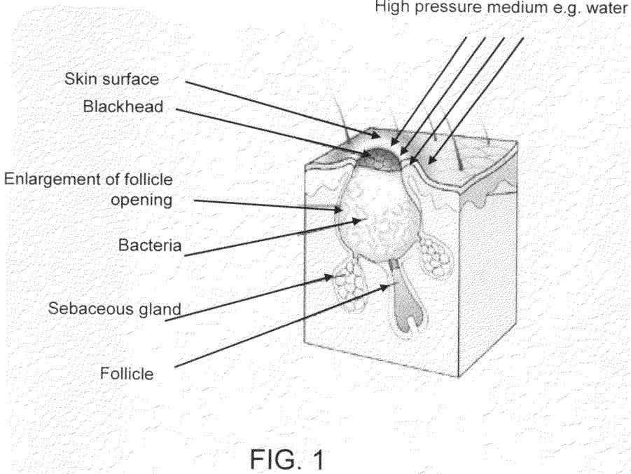

FIG. 1 is a schematic diagram illustrating an enlarged view of a pore of human skin. The pressure medium, such as water beam or stream with a controlled pressure, splashes on the blackhead and takes the immunities away. The water beam or stream may also enter the skin through the follicle opening and takes away the immunities, including bacteria, inside of the pore. The water beam or stream may also massage the skin surface areas where there are no pores.

To make the water molecules run at a very high speed, a very high pressure is needed. There are three basic ways to create high pressure of water. The first way is to push the water in a cylinder structure like the injector used by medical professionals. The source of the pushing force can be manual, mechanical or electrical.

The second way is to pump air into the water in an enclosed container such as a canister.

Yet the third way is to increase the temperature of the water in an enclosed container. For example, an electrical-heating device can be used to increase the temperature of the water.

For the purpose of this invention, the first and the second basic ways can be independently used. The third way is not preferable because the released hot water may damage the skin.

The invention provides a family of easy-to-use devices to clean impurities from human skin and at the same time to hydrate the skin in an effective and quick manner.

In the basic implementation, the apparatus includes a means for dispensing high pressure water to provide a water beam or stream, as a “water scraper”, a means for controlling the release of high pressure water, as a “switch” or “switching button” or “switching panel”, and a means for providing high pressure water, such as a canister prefilled with high-pressure water or a powered pump.

In one embodiment, no electrical or electronic devices are included. The apparatus is a pure mechanical device. The dispensing means can be fixed to the main body of the device. It can also be replaceable—after a period of the use, the user can install a new dispenser to the main body.

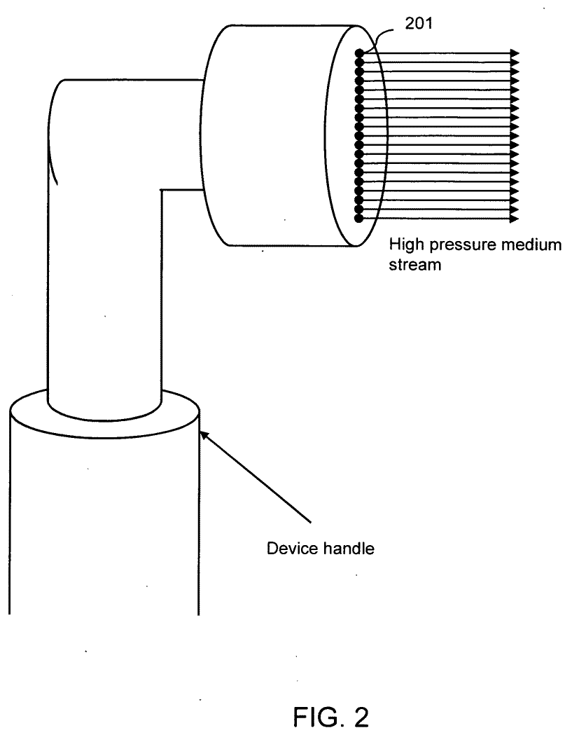

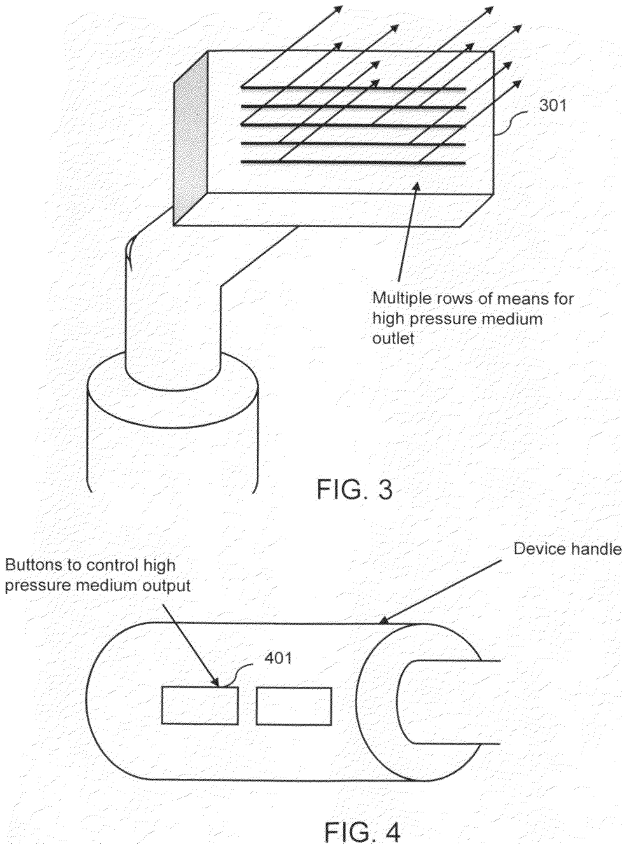

FIG. 2 is a schematic diagram illustrating the means for dispensing high pressure water according to the invention. The slim outlet 201, which provides a water beam or stream with a controlled pressure, may be vertical, horizontal, oblique, or curved. In an alternative implementation, the dispensing means may have multiple-layer outlets 301 as illustrated in FIG. 3. The pressures of water beams from different outlets can be same or slightly different. The handheld apparatus has a button 401 for the user to control the water pressure as illustrated in FIG. 4. In one typical implementation, the default status of the button 401 is “close” or “off. When the user pushes the button on, the water is released from the water source and further goes out through the outlet. When the user releases the button, the water stream is shut off.

In another embodiment, the means for releasing high pressure water is associated with an electronic device for adjusting water pressure. A list of preset pressure scale is provided. The user may select a proper pressure by pushing a button or by turning a tuner. The electronic device may be a mini CPU which controls the amount of water being released per second.

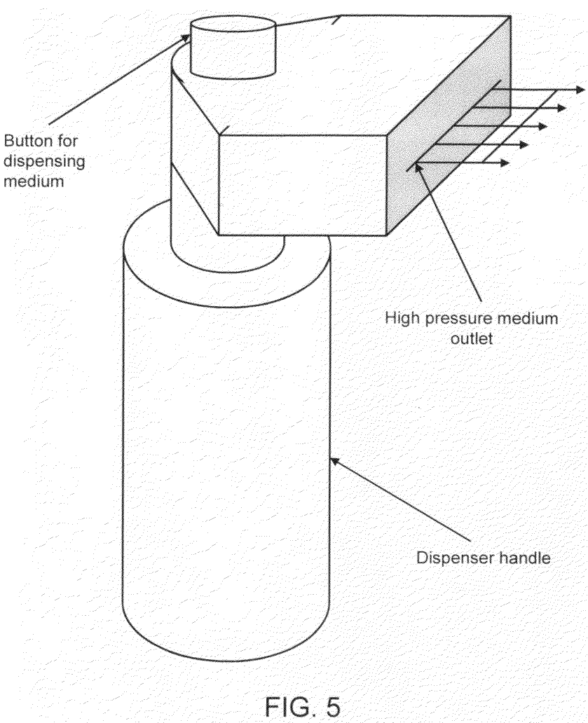

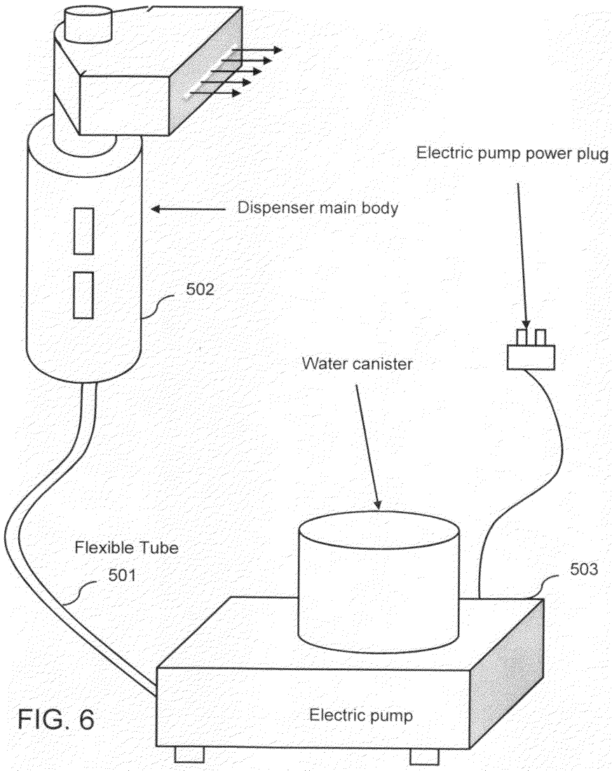

In another embodiment, the means for providing high pressure water is integrated with the main body of the device. For example, a canister can be installed in the dispenser handle as illustrated in FIG. 5. There is an interlocking mechanism between the main body (which is used as the dispenser handle) and the canister. When twisted in, the dispenser button is mechanically coupled to the outlet of the canister. When the high-pressured water runs out, the user may refill with water and recharge the pressure. The high pressure water providing means can also be disposable. When the water therein runs out, the user may twist it out and replace it with a new one.

In another embodiment, the means for providing high-pressured water is connected to the apparatus by a flexible pipe 501, from which the high-pressured water is conveyed to the dispensing means 502. The high-pressured water providing means can be an electrical powered pump 503 or the similar equipment.

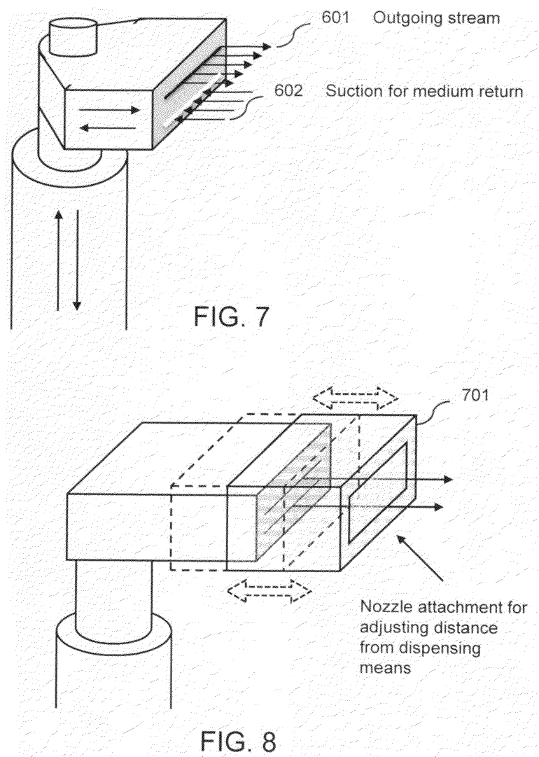

In another embodiment, the apparatus further includes a means for sucking the splashed water back to a container as illustrated in FIG. 7. The sucking means is integrated with the dispensing means or the “water scraper”. It is an inlet from which the water is sucked in. In operation, when the user pushes the button on, the high-pressured water stream 601 is released from the dispenser. The splashed water on the skin 602 is sucked into the inlet which is connected to a water container.

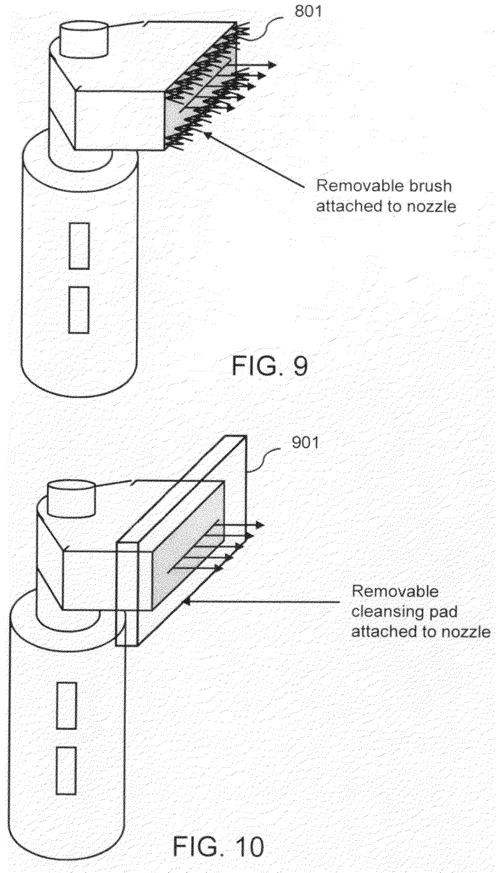

Yet in another embodiment, the apparatus further includes a means for keeping a distance from the dispensing means to the human skin (“distance means”) as illustrated in FIG. 8. The distance can be fixed or adjustable. The distance means 701 can be fixed to the main body, or can be detachable.

Yet in another embodiment, the apparatus further includes a removable brush 801 made of polythene or other materials as illustrated in FIG. 9.

Yet in another embodiment, the apparatus further includes a removable cleansing pad 901 attached to the dispensing nozzle as illustrated in FIG. 10.

Yet in another embodiment, the apparatus further includes a processor to control the water pressure. The processor can be either installed in the main body of the apparatus, or it can be installed in the pumping device. In the implementations for commercial use, the handheld apparatus is connected to a base which includes an electrical pump to provide high-pressured water for the handheld apparatus. The processor and the electronic controlling devices can be installed in the base. The button on the handheld apparatus can be connected to the controlling devices via electrical wire or via a wireless connection.

Yet in another embodiment, the apparatus includes a sensor, which is used to test the characteristics of the user's skin and is used by the processor to automatically adjust the water pressure of the dispensed water. The sensor can be a separate part, or it can be integrated with the main body of the apparatus. The apparatus may further include a database which stores the data for the processor to suggest the user to select water pressure, or for the processor to automatically set the water pressure for the user according to the characteristics of the user's skin.

Although pure water is preferred as stream medium, the invention can be implemented to use high-pressured steam or high-pressured air as the “scraping” media.

The invention can also be implemented to use “nutritional fluid” as media to scrape dirt off from human skin and at the same time inject (“feeding”) some nutritional factors into the skin. The scraping and the feeding functions can be fulfilled concurrently or separately. For the separate fulfillment implementation, a specific button or switch is designed. In such kind of implementation, the user who needs deep cleansing may use pure water, air, or steam as cleansing medium; and the user who just needs skin care by feeding the skin may use the “nutritional fluid” as medium. The user may select a proper type from a variety of pre-made media containers, such as “canisters”, twisting it on the main body of the apparatus, and then choose a proper button on the apparatus for performing a selected task.

The shape of the outlet or the dispensing means according to this invention may be oval, square, round, or any other shape. The surface facing to the skin, no matter it is flat or curved or curved with various grooves, must be super smooth such that when it contacts the skin, it will not scratch or hurt the skin surface.

In the typical implementations, the width of the slim water beam outlet is between half inch and two inches, and its height is between 5% and 150% of the diameter of an ordinary person's fine hair. The users who have relatively thin fine hair may choose the models of the product with relatively thin outlets. The users who have relatively thick fine hair may choose the models of the product with relatively thick outlets. Since the characteristics of female's and male's skins are quite different, female users and male users should use different models with appropriate size outlets.

While one or more embodiments of the present invention have been illustrated above, the skilled artisan will appreciate that modifications and adoptions to those embodiments may be made without departing from the scope and spirit of the present invention.

We claim:

1. An apparatus for deep skin cleansing comprising:
a means for dispensing a beam of high-pressured water;
a means for controlling release of said water beam; and
a means for providing high-pressured water.

2. The apparatus of claim 1, wherein said means for dispensing comprises multiple rows of outlets.

3. The apparatus of claim 1, wherein said means for providing high-pressured water is a replaceable canister prefilled with high-pressured water.

4. The apparatus of claim 1, wherein said means for providing high-pressured water comprises a powered pump.

5. The apparatus of claim 1, further comprising:
a means for sucking splashed water from surface area of the skin, said suction means comprising a pipe connected to a powered pump and an inlet parallel to said dispensing means.

6. The apparatus of claim 5, further comprising:
a means for activating said suction means.

7. The apparatus of claim 1, further comprising:
an adjustable nozzle attachment for adjusting distance from said dispensing means.

8. The apparatus of claim 1, further comprising:
a removable brush attached to said dispensing means.

9. The apparatus of claim 1, further comprising:
